(19) United States
(12) Patent Application Publication
(10) Pub. No.: US 2006/0225118 A1
(43) Pub. Date: Oct. 5, 2006

(54) Methods and systems for providing Internet protocol video over a multicast bonded group

(75) Inventors: James A. Rolls, Atlanta, GA (US); John T. Chapman, Saratoga, CA (US)

Correspondence Address: Merchant & Gould P.C., P.O. Box 2903, Minneapolis, MN, 55402-0903, US

(73) Assignee: Cox Communications, Inc.

(21) Appl. No.: 11/378,532

(22) Filed: Mar. 17, 2006

Related U.S. Application Data
(60) Provisional application No. 60/666,146, filed on Mar. 29, 2005.

(51) Int. Cl. H04N 7/173

(52) U.S. Cl. 725/118; 725/117

(57) ABSTRACT

Systems and methods are disclosed for providing feed streams, for example, over multiple channels and reassembling at least one feed stream received over the multiple channels. The disclosed systems and methods may include receiving a plurality of feed streams. Any one or more of the plurality of feed streams may comprise, for example, a broadcast video feed or a unicast video feed. Then, one of the plurality of feed streams may be configured, using an adjunct Modular Cable Modem Termination System (M-CMTS) engine, for one-way communications with an end use deice. Next, the plurality of feed streams may be aggregated, using a M-CMTS into a packetized data stream. Then the packetized data may be transmitted to a network. Furthermore, the packetized data stream may be striped across a plurality of channels before being transmitted the packetized data to the network.

### RELATED APPLICATION

Under provisions of 35 U.S.C. § 119(e), the Applicants claim the benefit of U.S. provisional application No. 60/666,146, entitled IP VIDEO OVER A MULTICAST BONDED GROUP, filed Mar. 29, 2005, which is incorporated herein by reference.

### BACKGROUND OF THE INVENTION

I. Field of the Invention

The present invention generally relates to methods and systems for providing Internet protocol video. More particularly, the present invention relates to providing Internet protocol video, for example, while bypassing a traditional Cable Modem Termination System (CMTS) or a Modular CMTS.

II. Background Information

In conventional analog cable television (TV) systems, program content is transmitted on 6 Mhz (8 MHz in Europe) channels with conventional TV sets being capable of tuning to 140 different channels. For example, content corresponding to CNN™ or ESPN™ may be delivered using one such channel. With the advent of digital television, the content associated with conventional analog TV channels may be digitized into feed streams using Moving Pictures Experts Group (MPEG.)

With conventional systems, a 6 MHz J.83 Annex B QAM Channel Modulated at 256 QAM has a bit rate of 42.88 Mbps before FEC and Trellis overhead and 38.81 Mbps of payload bandwidth after. In the context of digital feed streams, because each of the 6 MHz channels can carry 38.81 megabits per second and because each High Definition digital feed stream may be transmitted at approximately 9.5 megabits per second, up to four digital feed streams may be transmitted in one 6 Mhz channel. While digital cable TV may be an advantage over analog because, with digital, content associated with four conventional analog channels my be transmitted in one 6 Mhz channel, still a portion of the 6 Mhz channel's bandwidth may go unused with digital. For example, with five digital feed streams transmitting at 7 megabits per second, only 35 megabits per second are transmitted. Because 38.81 megabits per second may be transmitted in one 6 Mhz. channel, 3.81 megabits per second are wasted (i.e. 38.81 megabits per second−35 megabits per second=3.81 megabits per second or approximately 10% bandwidth waste.) This often causes problems because the conventional strategy does not take full advantage of the available bandwidth.

In view of the foregoing, there is a need for methods and systems for providing feed streams more optimally. Furthermore, there is a need for providing feed streams, for example, taking better advantage of the available bandwidth.

### SUMMARY

Systems and methods are disclosed for providing feed streams. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one embodiment, a method for providing feed streams comprises receiving a plurality of feed streams, configuring at least one of the plurality of feed streams for one-way communications with an end use deice, aggregating the plurality of feed streams into a packetized data stream, and transmitting the packetized data to a network.

According to another embodiment, a system for providing feed streams comprises a first component comprising a first memory storage and a first processing unit coupled to the memory storage. The first processing unit may be operative to receive a first feed stream and to configure the first feed stream for one-way communications with an end use deice. The system may further comprise a second component comprising a second memory storage and a second processing unit coupled to the memory storage. The second processing unit may be operative to receive a second feed stream, aggregate the first feed stream and the second feed stream into a packetized data stream, and transmit the packetized data to a network.

In accordance with yet another embodiment, a computer-readable medium which stores a set of instructions which when executed performs a method for providing feed streams, the method executed by the set of instructions comprising receiving a plurality of feed streams, configuring at least one of the plurality of feed streams for one-way communications with an end use deice, aggregating the plurality of feed streams into a packetized data stream, and transmitting the packetized data to a network.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary Internet protocol video system consistent with an embodiment of the present invention;

FIG. 2 is a diagram illustrating a bonding protocol consistent with an embodiment of the present invention;

FIG. 3 is a block diagram of an exemplary IP striping engine consistent with an embodiment of the present invention; and

FIG. 4 is a flow chart of an exemplary method for aggregating multiple streams over multiple channels and reassembling a stream received over the multiple channels consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions, or modifications may be made to the components illustrated in the drawings, and the exemplary methods described herein may be modified by substituting, reordering, or adding stages to the disclosed methods. Accordingly, the following detailed description does not limit the invention. Instead, the proper scope of the invention is defined by the appended claims.

Systems and methods consistent with embodiments of the present invention may provide Internet protocol video, for example, over a multicast bonded or unbonded group. Embodiments of the invention may provide a technique for cost effectively transporting a group of digital broadcast (switched or static) video channels across, for example, a hybrid fiber-coax (HFC) network using Internet protocol (IP) multicast. The channels may be provided over one large transmission convergence (TC) bonded transport or packet bonded transport. Using one large “pipe” for transport may allow for cost efficiency and efficient video channel multiplexing.

Embodiments of the invention may include processes for moving directly to video over IP for broadcast video distribution (bonded or unbonded), for example, in Data Over Cable Service Interface Specification (DOCSIS) 3.0, which may define interface standards for cable modems and supporting equipment. Further, embodiments of the invention may reduce the solution to were the IP multicast flows and the bonding process may bypass a Modular Cable Modem Termination System (M-CMTS) or an Integrated CMTS and be implemented in a more cost effective manner elsewhere. For example, an adjunct M-CMTS engine may be used to provide the aforementioned solution.

As will explained in more detail below, embodiments of the invention may deliver video or similar services using multicast or unicast over DOCSIS framing with optional MPEG-TS framing over Ethernet or a like network. This delivery may be performed using the adjunct M-CMTS engine while bypassing a traditional CMTS or a M-CMTS. Furthermore, this delivery may be performed in conjunction with a communication signaling control channel between the adjunct M-CMTS engine and the traditional CMTS or a M-CMTS. Moreover, the video or similar services may be delivered using bonding or not using bonding.

A M-CMTS may comprise a computerized device that enables cable modems to send and receive packets over the Internet. The M-CMTS may insert IP packets from the Internet into MPEG frames and transmit them to the cable modems via an RF signal. Other video compression processes may be used including Windows Media Video (WMV) 9 and VC-1, however, any video compression process may be used. Architectures used may include that all sources map their content onto MPEG packets (e.g. either bonded or non-bonded.) The aforementioned MPEG packets may then be passed to an edge network that may use quadrature amplitude modulation (QAM) that may perform a simple MPEG multiplex/scheduling and then may forward the MPEG packets to an HFC network downstream.

The Edge QAM may not be involved in packet manipulation, rather it may be an MPEG multiplexer followed by a QAM modulator and up-converter. This application may be just one of many applications that may be possible by maintaining an MPEG transport over User Datagram Protocol (UDP) to the Edge QAM from, for example, all sources. Alternatively, the interface may be a tunneled interface or a pseudowire interface, such as a Layer 2 Tunneling Protocol (L2TPv3) with extensions for the HFC Cable environment. One such interface is the Downstream External PHY Interface (DEPI). UDP may comprise a protocol on top of the Internet protocol (IP) protocol that may be used in place of TCP when a reliable delivery is not required. There may be less processing of UDP packets than there is for TCP. UDP may be used for realtime audio and video traffic where lost packets are simply ignored, because there is no time to retransmit. If UDP is used and a reliable delivery is required, packet sequence checking and error notification may be written into the applications.

An embodiment consistent with the invention may comprise a system for providing feed streams. The system may comprise a first component comprising a first memory storage and a first processing unit coupled to the memory storage. The first processing unit may be operative to receive a first feed stream and to configure the first feed stream for one-way communications with an end use deice. The system may further comprise a second component comprising a second memory storage and a second processing unit coupled to the memory storage. The second processing unit may be operative to receive a second feed stream, aggregate the first feed stream and the second feed stream into a packetized data stream, and transmit the packetized data to a network.

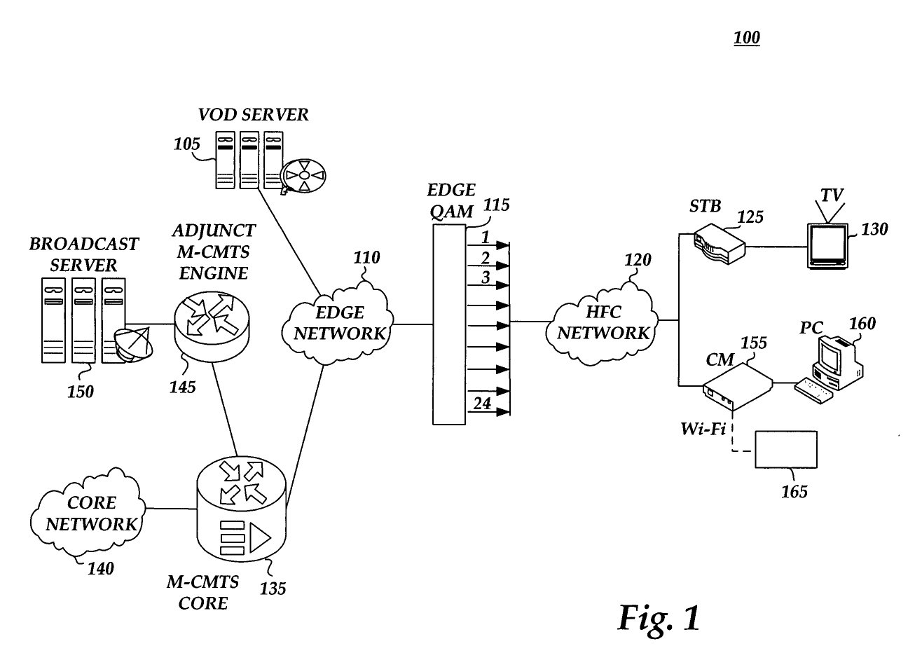

Consistent with an embodiment of the present invention, the aforementioned memory, processing unit, and other components may be implemented in a Internet protocol video system, such as an exemplary Internet protocol video system 100 of FIG. 1. Any suitable combination of hardware, software, and/or firmware may be used to implement the memory, processing unit, or other components. By way of example, the memory, processing unit, or other components may be implemented with any of a video on demand (VOD) server 105, an adjunct M-CMTS engine 145, or a broadcast server 150, in combination with system 100. The aforementioned system and processors are exemplary and other systems and processors may comprise the aforementioned memory, processing unit, or other components, consistent with embodiments of the present invention.

Another embodiment consistent with the invention may comprise a system for reassembling a stream received over multiple channels. The system may comprise a memory storage for maintaining a database and a processing unit coupled to the memory storage. The processing unit may be operative to receive a packetized data stream from the plurality of channels, identify packets within the packetized data stream associated with a one of the plurality of feed streams, and reassemble the identified packets into the one of the plurality of feed streams.

Consistent with another embodiment of the present invention, the aforementioned memory, processing unit, and other components may be implemented in a Internet protocol video system, such as an exemplary Internet protocol video system 100 of FIG. 1. Any suitable combination of hardware, software, and/or firmware may be used to implement the memory, processing unit, or other components. By way of example, the memory, processing unit, or other components may be implemented with any of a set top box (STB) 125 or a cable modem (CM) 155, in combination with system 100. The aforementioned system and processors are exemplary and other systems and processors may comprise the aforementioned memory, processing unit, or other components, consistent with embodiments of the present invention.

By way of a non-limiting example, FIG. 1 illustrates system 100 in which embodiments of the invention may be implemented. As illustrated in FIG. 1, system 100 may include VOD server 105, an edge network 110, an Edge QAM 115, an HFC network 120, STB 125, a television (TV) 130, an M-CMTS core 135, a core network 140, adjunct M-CMTS engine 145, broadcast server 150, CM 155, a personal computer (PC) 160, and a portable device 165 using wireless fidelity (Wi-Fi), for example. System 100 may generate MPEG packets over IP datagrams that can then be received by Edge QAM 115. The sources shown in FIG. 1 (e.g. servers 105 and 150) may be capable of spreading their content across multiple QAM channel using TC or packet bonding, thus creating a large bonded channel. This bonding feature may be performed by M-CMTS Core 135 or adjunct M-CMTS engine 145, but can also be implemented in other devices shown in FIG. 1.

VOD server 105 may take MPEG compressed video off of a hard disk, format it into MPEG-TS packets inside of an UDP packet, and send it into edge network 110. The UDP packets may be received by Edge QAM 115, where the IP encapsulation may be removed, and the MPEG packets forwarded down one QAM channel onto HFC network 120. HFC network 120 may comprise a communications network (e.g. a cable TV network) that uses a combination of optical fibers and coaxial cable. The fiber may provide the high-speed backbone and the coax may be used to connect end users to the backbone. Such networks typically use, for example, matching DOCSIS cable modems at the head end and at the customer premises, providing bidirectional paths and Internet access. The MPEG packets may be received by STB 125 where the video may be removed, decompressed, and sent to TV 130. STB 125 may include all the functionality provided by a cable modem such as CM 155, for example.

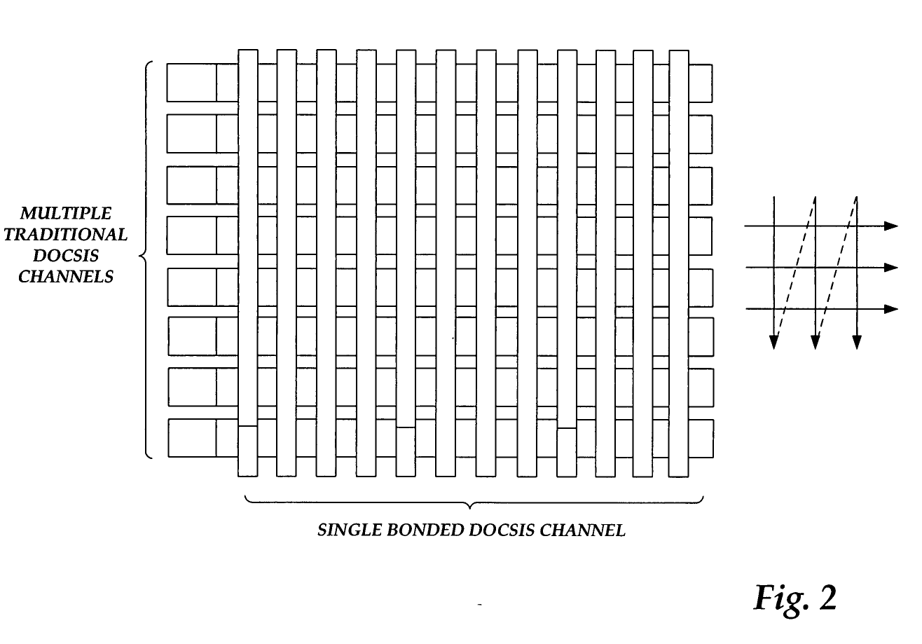

M-CMTS core 135 may receive IP datagrams from core network 140. M-CMTS core 135 may then forward these IP datagrams to either a single QAM channel within Edge QAM 115 with traditional DOCSIS encapsulation, or may forward the IP datagrams to multiple QAM channels within Edge QAM 115 using DOCSIS bonding. Embodiments of the invention may use TC layer bonding. The transmission convergence layer, in the case of DOCSIS, may map the DOCSIS MAC frame into MPEG packets. Accordingly, a downstream bonded channel may be created by taking DOCSIS frames, putting them into MPEG packets, and placing those MPEG packets onto QAM channels. However, instead of placing the MPEG packets “horizontally” in time along a single QAM carrier as is done in traditional DOCSIS, the TC bonding protocol places the MPEG packets “vertically” across the QAM channels as illustrated in FIG. 2. Consequently, a DOCSIS frame may be tipped on its side and “striped” across a group of QAM channels. The TC bonded packets may be transported from M-CMTS core 135 to the Edge QAM 115 using an MPEG packet over IP protocol, the same protocol, for example, as VOD server 105 uses. Edge QAM 115 may receive the IP packets and may remove the MPEG packets. Edge QAM 115 may then schedule (i.e. multiplex) the MPEG packets from each source onto the QAM channels.

Adjunct M-CMTS engine 145 may take a large number of high bandwidth video channels from broadcast server 150. These video channels, for example, may be sent to adjunct M-CMTS engine 145 using IP multicast. Adjunct M-CMTS engine 145 may take the IP multicast packets and map them into MPEG packets. Adjunct M-CMTS engine 145 may use TC bonding or packet bonding techniques to distribute these packets across a number of virtual QAM channel queues. The output of these queues may be used to create MPEG over IP packets that may then get sent to each QAM channel within the Edge QAM 115. Adjunct M-CMTS engine 145 may use the same interface protocol as VOD server 105 and M-CMTS core 135. Edge QAM 115 may schedule (i.e. multiplex) the MPEG packets from each of these sources onto the QAM Channels. A TC bonding or packet bonding aware STB (such as STB 125) may receive the bonded channels, extract the IP multicast channels, select the IP multicast channel that it subscribes to, extract the video, and send to TV 130.

Consistent with embodiments of the invention, adjunct M-CMTS engine 145 may configure at least one feed stream (e.g. a video channel from broadcast server 150) for one-way communications with an end use deice such as STB 125 or CM 155. Because adjunct M-CMTS engine 145 may only need to configure feed streams for one-way communications in a “nailed-up” manner, it may be constructed more simply and less expensively than M-CMTS core 135. For example, M-CMTS core 135 configures packets it processes for two-way communication with an end use deice. However, because packets processed by adjunct M-CMTS engine 145 may be associated with broadcast or unicast content, the packets processed by adjunct M-CMTS engine 145 may not need to be configured for two-way communication, rather one-way communication may be sufficient. Accordingly, because adjunct M-CMTS engine 145 may process one-way packets, adjunct M-CMTS engine 145 may constructed more simply and less expensively than M-CMTS core 135.

Adjunct M-CMTS engine 145 may comprise a device separate from M-CMTS core 135 or may reside, for example, in a card within M-CMTS core 135. In operation, adjunct M-CMTS engine 145 may have a separate interface to edge network 110 or may use M-CMTS core 135's interface with edge network 110. Furthermore, adjunct M-CMTS engine 145 may work in conjunction with M-CMTS core 135 using a communication signaling control channel between adjunct M-CMTS engine 145 and M-CMTS core 135 at least to perform resource allocation. In other words, M-CMTS core 135 may be aware of adjunct M-CMTS engine 145 and thus adjunct M-CMTS engine 145 and M-CMTS core 135 may work together to figure out which channel group CM 155 should be on. For example, M-CMTS core 135 may advertise by sending a messages to CM 155 that may indicate the channels that M-CMTS core 135 wants CM 155 to listen. Edge QAM 115 may have 24 channels, but CM 155 may only be capable of receiving 12 channels. Furthermore, CM 155 may be on the bottom 12 channels or may be on the top 12 channels. Unfortunately, adjunct M-CMTS engine 145 may attempt to communicate with CM 155 on some of the channels CM 155 is not listening to. Consequently, because M-CMTS core 135 may be capable of moving CM 155 between channels and adjunct M-CMTS engine 145 may not have this capability, adjunct M-CMTS engine 145 may communicate with M-CMTS core 135 to perform this channel move.

Furthermore, consistent with embodiments of the invention, an entire analog broadcast line-up can be replaced by a digital channel line-up that may take significantly less bandwidth because of digital compression. However, the use of high definition television (HDTV), for example, may take back some of the bandwidth freed by digital compression. One way of implementing this system may include using IP multicast to carry each video stream, place all the video streams into one large pipe, and put that pipe down HFC network 120. That one large pipe may be a bonded DOCSIS pipe. By further restricting the operation of the one large pipe, it may be possible to bypass M-CMTS Core 135 and locate adjunct M-CMTS engine 145 either as a separate device or within an ethernet switch, router, or other network device. The number of QAM channels to use for a bonding group may depend upon, for example, the amount of content that needs to be sent and the number of QAM channels that can be received by STB 125. For example, 16 or 24 QAM channels may be used. 24 QAM channels may correspond to a gigabit of content, which may be a convenient number for networking. Since all video channels may share one large pipe, each video channel can be any bandwidth. In other words, there may be no need to evenly divide the pipe up into smaller fixed segments as is done in conventional systems. This may allow multiple bit rates to be easily packed together. On a smaller pipe, such as a single QAM channel, some combinations of HDTV and standard definition television (SDTV) feeds may not fit efficiently. By using a larger pipe, the issue of not completely packing a QAM channel may be eliminated.

Consistent with embodiment of the invention, the need to pass, for example, the IP multicast video flows through M-CMTS core 135 may be eliminated. Furthermore, adjunct M-CMTS engine 145 may be operated in a static configuration. For example, a known set of multicast channels may be allowed through adjunct M-CMTS engine 145. This may be enforced through the use of access lists. In addition, the total bandwidth of this known set of multicast groups may be less than the bandwidth of the large pipe. This may eliminate the need for classifying, rate shaping, and service flows. This operation may be further enhanced and made dynamic through using admission control. Multicast flows may be added and deleted. Admission control on adjunct M-CMTS engine 145 may deny new flows if the calculated maximum bandwidth were to exceed the available bandwidth. Some of the variants that exist on this approach are to mark part of the video streams that could be dropped with a lower priority. Then the maximum bandwidth allowed by admission control may be some percentage higher than the actual bandwidth. With the large number of video flows involved, for example, on a gigabit pipe (100-200), it may be statistically unlikely that all the peaks will line up at once. Thus, there is some percentage of over-subscription that may still result in very few, if any, packet drops.

Regarding IP addressing, consistent with embodiments of the invention, end points that may be receiving the IP multicast streams may have a separate DOCSIS connection. The separate DOCSIS connection may provide the end point (such as STB 125) with an IP address. This second path through the network, which may terminate on a separate logical port on the end point, may have a separate IP address. However, if all the traffic on this second path is multicast traffic, then none of the packets in that stream may need to contain the IP address of the end point. Thus, it may be possible to manage this system with only one IP address per end point.

With respect to multicast signaling, there are two scenarios of multicast sessions that may be considered, static setup and dynamic setup. A static configuration, for example, may be a reasonable approach to use for initial market deployment. If the application is to take all the broadcast channels and make them available in digital over IP all the time, adjunct M-CMTS engine 145 can be statically configured to be a member of all the appropriate multicast groups.

Dynamic configuration of adjunct M-CMTS engine 145 may imitate the concept of switched broadcast where broadcast channels may only be sent down to portions of HFC network 120 where there may be a viewer who wants to watch them. This may conserve bandwidth as it may be unlikely that all broadcast channels are being watched at the same time. To implement the dynamic configuration, the end point (such as STB 125) may send an Internet Group Multicast Protocol (IGMP) message to join up the DOCSIS link. M-CMTS core 135 may receive this join and recognize, through the value of the multicast address or through some other form of configuration, that the IP multicast stream is to be transported through adjunct M-CMTS engine 145 instead of M-CMTS core 135. CMTS core 135 may then pass the IGMP join (or equivalent construct) to adjunct M-CMTS engine 145 that may then proceed with admission control and do the multicast join. In this scenario, M-CMTS core 135 may be acting as an IGMP proxy for adjunct M-CMTS engine 145. Moreover, there may be additional multicast signaling messages, such as membership reports, that may get proxied as well.

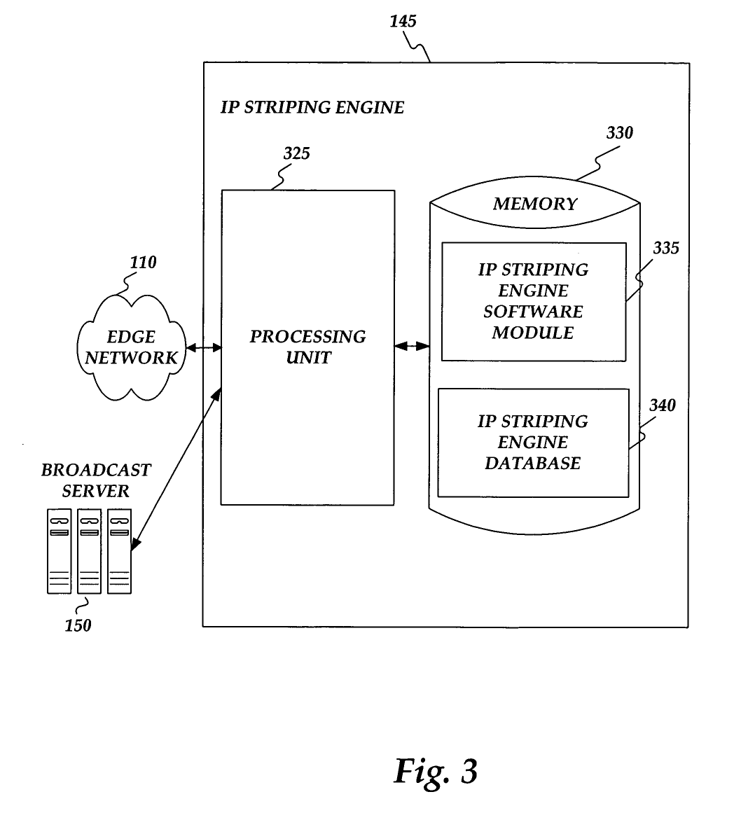

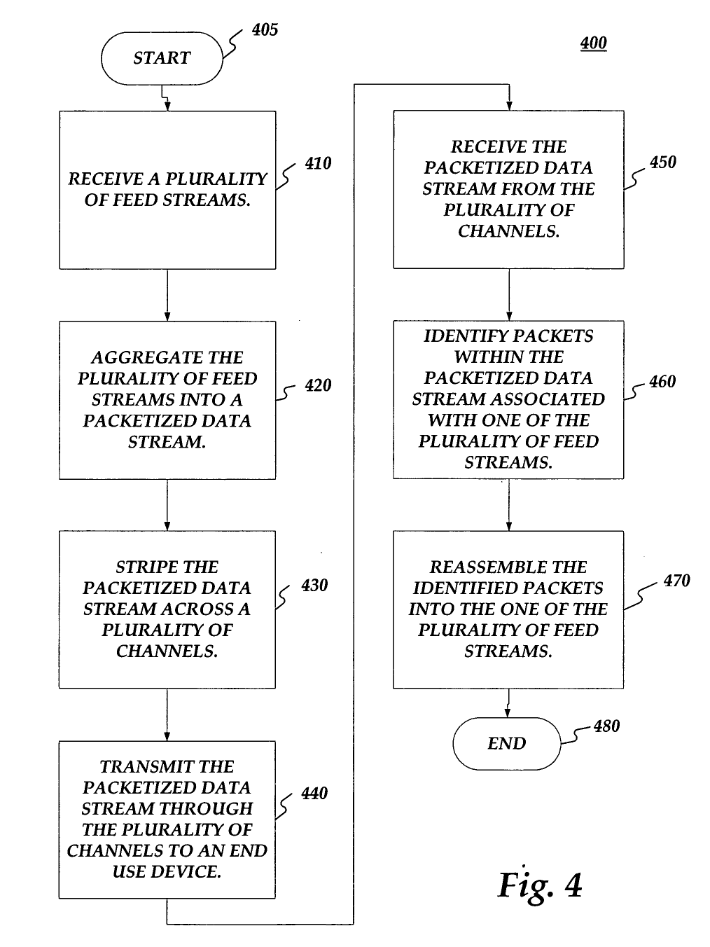

FIG. 3 shows adjunct M-CMTS engine 145 of FIG. 1 in more detail. As shown in FIG. 3, adjunct M-CMTS engine 145 may include a processing unit 325 and a memory 330. Memory 330 may include an IP striping software module 335 and an IP striping database 340. While executing on processing unit 325, IP striping software module 335 may perform processes for aggregating multiple streams over multiple channels, for example, one or more of the stages of method 400 described below with respect to FIG. 4. Furthermore, any combination of software module 335 and database 340 may be executed on or reside in any one or more of the elements as shown in FIG. 1.

Adjunct M-CMTS engine 145 (“the processor”) included in system 100 may be implemented using a personal computer, network computer, mainframe, or other similar microcomputer-based workstation. The processor may though comprise any type of computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. The aforementioned systems and devices are exemplary and the processor may comprise other systems or devices.

FIG. 4 is a flow chart setting forth the general stages involved in an exemplary method 400 consistent with an embodiment of the invention for aggregating multiple streams over multiple channels and reassembling a stream received over the multiple channels using system 100 of FIG. 1. Exemplary ways to implement the stages of exemplary method 400 will be described in greater detail below. Exemplary method 400 may begin at starting block 405 and proceed to stage 410 where adjunct M-CMTS engine 145 may receive a plurality of feed streams. For example, adjunct M-CMTS engine 145 may receive feed streams from broadcast server 150. The feed streams may correspond to particular TV programming providers such as CNN™ or ESPN™, but are not limited to broadcast and may included multicast or unicast, for example. The aforementioned are exemplary and the feed streams may comprise other feed types or content.

From stage 410, where adjunct M-CMTS engine 145 receives the plurality of feed streams, exemplary method 400 may advance to stage 420 where adjunct M-CMTS engine 145 may aggregate the plurality of feed streams into a packetized data stream. For example, the feed streams may each be in an analog or a digital format. If analog, the feed stream may be digitized. The digitized format may comprise, but is not limited to, MPEG. Individual packets (e.g. MPEG packets) corresponding to all of the plurality of feed streams may be addressed using IP, for example, and placed into one stream comprising the packetized data stream. Furthermore, the individual packets may be configured by adjunct M-CMTS engine 145 for one-way communication to an enduse device such as STB 125 or CM 155

Once adjunct M-CMTS engine 145 aggregates the plurality of feed streams into the packetized data stream in stage 420, exemplary method 400 may continue to stage 430 where adjunct M-CMTS engine 145 may stripe the packetized data stream across a plurality of channels using TC or packet bonding techniques. For example, each of the plurality of channels may comprise cable television channels comprising 6 Mhz downstream each. Packets from the packetized data stream may be striped (or inverse multiplexed) across all of the plurality of channels. For example, the plurality of channels may comprise three television channels comprising 6 Mhz each. From the packetized data stream, a first packet may be placed in a first channel, a second pack may be placed in a second channel, and a third packet may be place in a third channel. Then a forth packet may be placed in the first channel, a fifth pack may be placed in the second channel, and a sixth packet may be place in the third channel. This may be repeated continuously, filling-up the bandwidth in each of the three channels. This may provide an advantage over conventional systems because each of the plurality of channels may be used closer (or completely) to their full capacity.

After adjunct M-CMTS engine 145 stripes the packetized data stream across the plurality of channels in stage 430, exemplary method 400 may proceed to stage 440 where adjunct M-CMTS engine 145 may transmit the packetized data stream through the plurality of channels to an end use device. For example, the packetized data stream, now striped across the plurality of channels, may be transmitted through elements of system 100 including edge network 110, Edge QAM 115, and HFC network 120.

From stage 440, where adjunct M-CMTS engine 145 transmits the packetized data stream through the plurality of channels to the end use device, exemplary method 400 may advance to stage 450 where STB 125 or CM 155 may receive the packetized data stream from the plurality of channels. Once STB 125 or CM 155 receives the packetized data stream from the plurality of channels in stage 450, exemplary method 400 may continue to stage 460 where STB 125 or CM 155 may identify packets within the packetized data stream associated with one of the plurality of feed streams. For example, each of the packets received may be in IP format. Accordingly, each packet may be addressed or coded with information indicating which feed stream it corresponds to and where it fits in the feed stream.

After STB 125 or CM 155 identifies packets within the packetized data stream in stage 460, exemplary method 400 may proceed to stage 470 where STB 125 or CM 155 may reassemble the identified packets into the one of the plurality of feed streams. For example, STB 125 or CM 155 may read each received packet to determine its corresponding feed stream, strip off the IP, and reassemble, for example, one or more of the MPEG stream associated with the plurality of feed streams. After STB 125 or CM 155 reassembles the identified packets in stage 470, exemplary method 400 may then end at stage 480.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention may be embodied as systems, methods, and/or computer program products. Accordingly, the present invention may be embodied in hardware and/or in software (including firmware, resident software, micro-code, etc.). Furthermore, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention are described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention may exist. Furthermore, although embodiments of the present invention have been described as being associated with data stored in memory and other storage mediums, these aspects can also be stored on or read from other types of computer-readable media, such as secondary storage devices, like hard disks, floppy disks, or a CD-ROM, a carrier wave from the Internet, or other forms of RAM or ROM. Further, the stages of the disclosed methods may be modified in any manner, including by reordering stages and/or inserting or deleting stages, without departing from the principles of the invention.

It is intended, therefore, that the specification and examples be considered as exemplary only, with a true scope and spirit of the invention being indicated by the following claims and their full scope of equivalents.

What is claimed is:

1. A method for providing feed streams, the method comprising:
receiving a plurality of feed streams;
configuring at least one of the plurality of feed streams for one-way communications with an end use deice;
aggregating the plurality of feed streams into a packetized data stream; and
transmitting the packetized data to a network.

2. The method of claim 1, further comprising striping the packetized data stream across a plurality of channels before transmitting the packetized data to the network.

3. The method of claim 2, wherein striping the packetized data stream across the plurality of channels further comprises striping the packetized data stream across the plurality of channels comprising six megahertz (MHz) cable television channels.

4. The method of claim 2, wherein striping the packetized data stream across the plurality of channels further comprises utilizing inverse multiplexing.

5. The method of claim 2, further comprising transmitting the packetized data stream through the plurality of channels to the end use device.

6. The method of claim 1, wherein receiving the plurality of feed streams further comprises receiving the plurality of feed streams wherein at least one of the plurality of feed streams corresponds to at least one of the following: a broadcast video feed and a unicast video feed.

7. The method of claim 1, wherein aggregating the plurality of feed streams into the packetized data stream further comprises aggregating the plurality of feed streams into the packetized data stream comprising an Internet protocol (IP) data stream.

8. The method of claim 1, wherein configuring the at least one of the plurality of feed streams for one-way communications further comprises configuring the at least one of the plurality of feed streams for one-way communications using an adjunct Modular Cable Modem Termination System (M-CMTS) engine.

9. The method of claim 1, wherein aggregating the plurality of feed streams into the packetized data stream further comprises aggregating the plurality of feed streams into the packetized data stream using a Modular Cable Modem Termination System (M-CMTS).

10. A system for providing feed streams, the system comprising:
a first component comprising:
a first memory storage; and
a first processing unit coupled to the memory storage, wherein the first processing unit is operative to:
receive a first feed stream; and
configure the first feed stream for one-way communications with an end use deice; and
a second component comprising:
a second memory storage; and
a second processing unit coupled to the memory storage, wherein the second processing unit is operative to:
receive a second feed stream;
aggregate the first feed stream and the second feed stream into a packetized data stream; and
transmit the packetized data to a network.

11. The system of claim 10, wherein the second processing unit is further operative to stripe the packetized data stream across a plurality of channels.

12. The system of claim 11, wherein the second processing unit being operative to stripe the packetized data stream across a plurality of channels further comprises the second processing unit being operative to stripe the packetized data stream across the plurality of channels comprising six megahertz (MHz) cable television channels.

13. The system of claim 11, wherein the second processing unit being operative to stripe the packetized data stream across the plurality of channels further comprises the second processing unit being operative to stripe the packetized data stream across the plurality of channels utilizing inverse multiplexing.

14. The system of claim 11, further comprising the second processing unit being operative to transmit the packetized data stream through the plurality of channels to the end use device.

15. The system of claim 10, wherein the first processing unit being operative to receive the first feed stream further comprises the first processing unit being operative to receive the first feed stream wherein the first feed stream corresponds to at least one of the following: a broadcast video feed and a unicast video feed.

16. The system of claim 10, wherein the second processing unit being operative to aggregate the first feed stream and the second feed stream into a packetized data stream further comprises the second processing unit being operative to aggregate the first feed stream and the second feed stream into a packetized data stream comprising an Internet protocol (IP) data stream.

17. The system of claim 10, wherein the first component comprises an adjunct Modular Cable Modem Termination System (M-CMTS) engine.

18. The system of claim 10, wherein the second component comprises a Modular Cable Modem Termination System (M-CMTS).

19. A computer-readable medium which stores a set of instructions which when executed performs a method for providing feed streams, the method executed by the set of instructions comprising:
receiving a plurality of feed streams;
configuring at least one of the plurality of feed streams for one-way communications with an end use deice;
aggregating the plurality of feed streams into a packetized data stream; and
transmitting the packetized data to a network.

20. The computer-readable medium of claim 19, wherein configuring the at least one of the plurality of feed streams for one-way communications further comprises configuring the at least one of the plurality of feed streams for one-way communications using an adjunct Modular Cable Modem Termination System (M-CMTS) engine.
